(19) United States
(12) Patent Application Publication
(10) Pub. No.: US 2025/0158181 A1
(43) Pub. Date: May 15, 2025

(54) BATTERY AND BATTERY MANUFACTURING METHOD

(71) Applicant: TOYOTA JIDOSHA KABUSHIKI KAISHA, Toyota-shi (JP)

(72) Inventor: Atsushi SUGIHARA, Toyota-shi (JP)

(73) Assignee: TOYOTA JIDOSHA KABUSHIKI KAISHA, Toyota-shi (JP)

(21) Appl. No.: 18/921,473

(22) Filed: Oct. 21, 2024

(30) Foreign Application Priority Data
Nov. 15, 2023 (JP) 2023-194668

(51) Int. Cl. H01M 50/183; H01M 4/02; H01M 10/0585; H01M 50/103

(52) U.S. Cl. CPC H01M 50/183; H01M 10/0585; H01M 50/103; H01M 2004/029

(57) ABSTRACT

A battery of the present disclosure includes an electrode stack assembly containing plural electrodes, a sealing frame, and a non-aqueous electrolyte. The electrode includes a current collector and at least one out of a cathode layer or an anode layer. The electrode includes a non-coated portion. The sealing frame includes a sealing frame member welded to at least part of the non-coated portion of at least one out of the one-face or the other-face of the current collector for each of the plurality of electrodes.

### CROSS-REFERENCE TO RELATED APPLICATION

This application is based on and claims priority under 35 USC § 119 from Japanese Patent Application No. 2023-194668 filed on Nov. 15, 2023, the disclosure of which is incorporated by reference herein.

### TECHNICAL FIELD

The present disclosure relates to a battery, and a battery manufacturing method.

### RELATED ART

Japanese Patent Application Laid-Open (JP-A) No. 2023-000059 (Patent Document 1) discloses a method to manufacture a power storage device (hereafter referred to as a “battery”). This manufacturing method includes a preparation process, a melting process, and a particular molding process. A stack assembly is prepared in the preparation process. The stack assembly includes plural current collectors that are each provided with an active material layer, and plural sealing members. The sealing members exhibit a frame shape surrounding the active material layers when viewed along the thickness direction of the current collectors, and include extension portions that extend outward from outer edges of the current collectors. The sealing members are disposed between the respective plural current collectors. In the welding process, the plural sealing members are melted by non-contact heating to configure the plural sealing members, and a side face is formed that includes a communication port for communication between the inside and outside of the stack assembly.

Specifically, a stack assembly 900 illustrated in FIG. 9 is prepared in the preparation process. The stack assembly 900 includes plural electrode units 910, plural separators 920, and plural spacers 930. The electrode units 910, the separators 920, and the spacers 930 are stacked in this sequence along a stacking direction D1. The electrode units 910 each include a bipolar electrode 911 and a sealing member 912. The bipolar electrode 911 includes a current collector 9111, a cathode active material layer 9112, and an anode active material layer 9113. The cathode active material layer 9112 is provided to a one-face S9111A of the current collector 9111. The anode active material layer 9113 is provided to an other-face S9111B of the current collector 9111. The sealing member 912 is joined to the one-face S9111A and to the other-face S9111B of the current collector 9111 at a peripheral edge portion of the current collector 9111. A one-face S912 of the sealing member 912 is a flat face. A one-face S930 of the spacer 930 is a flat face. A gap G is accordingly formed between the one-face S912 of the sealing member 912 and the one-face S930 of the spacer 930.

As illustrated in FIG. 9, an infrared heater 800 is employed in the welding process to radiate infrared rays onto a side face S900 of the stack assembly 900, and to weld the interfaces between the sealing members 912 and the spacers 930 so as to integrate them together. A sealing section 940 is formed thereby. The particular molding process is executed next. A battery 901 as illustrated in FIG. 10 is obtained thereby.

When cooling-heating cycle tests are performed on the battery 901 for cases in which the entire area of the interface between the sealing member 912 and the spacer 930 has been welded, then there is a concern that cracks caused by changes in volume of the sealing section 940 might develop in the sealing section 940. Reference here to “cooling-heating cycle tests” indicates tests in which the battery 901 is exposed plural times to alternately a high temperature atmosphere and a low temperature atmosphere. There is a concern regarding leakage of non-aqueous electrolyte when cracks develop in the sealing section 940. Namely, there is a concern that the battery 901 might lack sufficient scaling ability.

The present inventors have confirmed by testing that making a length, in a direction D2 orthogonal to the stacking direction D1, of a weld area of the sealing member 912 (for example, an area where the interface between the sealing member 912 and the spacer 930 is welded) (hereafter referred to as “weld length”) shorter than a length L901 between the side face S901 of the battery 901 and an end face of the current collector 9111 is effective in suppressing the development of cracks in the sealing section 940. This is thought to be because local stress caused by change in volume is less liable to be imparted to the sealing section 940 than cases in which the entire area of the interface between the sealing member 912 and the spacer 930 is welded.

However, in the stack assembly 900, the current collector 9111 is not present at the peripheral edge of the electrode unit 910. This means that the thickness of the peripheral edge of the electrode unit 910 is thinner than the thickness at a central portion of the electrode unit 910. Furthermore, as illustrated in FIG. 9, a gap G is formed at the peripheral edge of the stack assembly 900. This means that molten material from the sealing member 912 or the spacer 930 might flow into the gap G when the welding process is executed, leading to a concern that deformation might occur to the shape of the peripheral edge of the stack assembly 900. Namely, there is a concern that a side face of the battery 901 configured by the sealing section 940 might become a sloping face. This means that in the stack assembly 900 it is difficult to control a weld length to achieve a battery 901 having excellent scaling ability (to suppress development of cracks in the sealing section 940).

On the other hand, a length L901 (see FIG. 10) could conceivably be designed so as to be longer to achieve a battery 901 having excellent sealing ability. However, the sealing member 912 and the spacer 930 do not directly contribute to the battery reaction. This means that were the length L901 (see FIG. 10) to be designed so as to be longer then this would lead to a drop in structural efficiency of the battery 901. Reference here to “structural efficiency” indicates a proportion of a volume of electrode assembly where the battery reaction is performed with respect to an overall volume of the battery.

There is accordingly demand for a battery having excellent structural efficiency. Furthermore, there is demand for a battery manufacturing method capable of manufacturing a battery having excellent structural efficiency.

### SUMMARY

The present disclosure has been arrived at in consideration of the above circumstances. An issue addressed by one embodiment of the present disclosure is to provide a battery having excellent structural efficiency. An issue addressed by another embodiment of the present disclosure is to provide a battery manufacturing method capable of manufacturing a battery having excellent structural efficiency and excellent sealing ability.

Means to address the above issues include the following aspects.

<1> A battery of a first aspect includes an electrode stack assembly containing plural electrodes stacked in a stacking direction with a separator interposed therebetween, a sealing frame that seals a side peripheral face of the electrode stack assembly and that forms a housing portion between adjacent electrodes from out of the plural electrodes, and a non-aqueous electrolyte that is housed in the housing portion.

The electrode includes a current collector and at least one out of a cathode layer or an anode layer. The electrode includes a non-coated portion where neither the cathode layer nor the anode layer are formed on a one-face and an other-face of the current collector. The sealing frame includes a sealing frame member welded to at least part of the non-coated portion of at least one out of the one-face or the other-face of the current collector for each of the plural electrodes. The battery satisfies following (A) or (B).
(A): The sealing frame further includes a spacer arranged between two adjacent sealing frame members from out of the plural sealing frame members. At a portion of the spacer contacting the two adjacent sealing frame members, the spacer includes a first flat face location and a protruded location that projects out in the stacking direction from the first flat face location. At a portion of the sealing frame member contacting the two adjacent spacers, the sealing frame member includes a second flat face location contacting the first flat face location, and an indented location depressed in the stacking direction from the second flat face location. The protruded location fits together with the indented location.
(B): The sealing frame members are each welded to at least part of the non-coated portion of the one-face or the other-face of the current collector. The sealing frame member includes an extension portion that extends from the current collector in a plane direction of the current collector orthogonal to the stacking direction. The extension portion directly contacts an adjacent sealing frame member.

The battery of the first aspect satisfies (A) or (B).

In cases in which the battery of the first aspect satisfies (A), the protruded location of the spacers fit together with the indented location of the sealing frame members. Namely, a void is not liable to form at the interfaces between the spacers and the sealing frame members. This means that the shape of the sealing frame member is not liable to deform when welding the sealing frame member. This means that the side face of the battery configured with the sealing frame member is a perpendicular face. As a result thereof the battery of the first aspect has excellent structural efficiency.

In cases in which the battery of the first aspect satisfies (B), the extension portion directly contacts the adjacent sealing frame member. Namely, a void is not liable to form at the interfaces between the two adjacent sealing frame members from out of the sealing frame members. This means that the shape of the sealing frame member is not liable to deform when welding the sealing frame member. This means that a side face of the battery configured with the sealing frame member is a perpendicular face. As a result thereof the battery of the first aspect has excellent structural efficiency.

<2> A battery of a second aspect is the battery of the <1>, wherein:
in cases in which the (A) is satisfied, in a cross-section sectioned along a direction parallel to the stacking direction, a length in a direction orthogonal to the stacking direction of a welded location of an interface between the spacer and the sealing frame member from a side face of the sealing frame is shorter than a length from the sealing frame side face to the current collector; and
in cases in which the (B) is satisfied, in a cross-section sectioned along a direction parallel to the stacking direction, a length in a direction orthogonal to the stacking direction of a welded location of an interface between the adjacent sealing frame members from a side face of the sealing frame is shorter than from a length from the sealing frame side face to the current collector.

In the second aspect, in cases in which (A) is satisfied, local stress caused by change in volume is less liable to be imparted to a sealing section than cases in which the entire area of the interface between the sealing frame member and the spacer is welded. As a result thereof, cracks are not liable to develop in the sealing frame even when cooling-heating cycle tests are executed on the battery of the second aspect. Namely, the battery of the second aspect has excellent scaling ability.

In the second aspect, in cases in which (B) is satisfied, local stress caused by change in volume is less liable to be imparted to a sealing section than cases in which the entire area of the interface between the two adjacent sealing frame members from out of the sealing frame members is welded. As a result thereof, cracks are not liable to develop in the sealing frame even when cooling-heating cycle tests are executed on the battery of the second aspect. Namely, the battery of the second aspect has excellent sealing ability.

<3> A battery of a third aspect of the present disclosure is the battery of the <1> or the <2> wherein the (A) is satisfied, and a height in the stacking direction of the protruded location from the first flat face location of the spacer is from 0.25 times to 1 time a thickness of the current collector.

Thus in the battery of the third aspect, the quality of contact between the spacer and the sealing frame member is superior to configurations in which the height in the stacking direction of the protruded location from the first flat face location of the spacer is outside of the range of 0.25 times to 1 times the thickness of the current collector.

<4> A battery of a fourth aspect of the present disclosure is the battery of the <1> or the <2>, wherein the (B) is satisfied, the sealing frame member includes a projection portion on the extension portion that projects out from a welded surface welded to the current collector, and a thickness in the stacking direction of the projection portion from the welded surface is from 1 time to 2 times a thickness of the current collector.

Thus in the battery of the fourth aspect, the quality of contact between the two adjacent sealing frame members is superior to configurations in which the thickness in the stacking direction of the projection portion from the welding face is outside of the range of 1 time to 2 times the thickness of the current collector.

<5> A battery manufacturing method of a fifth aspect of the present disclosure is a method of manufacturing the battery of any one of <1> to <3> satisfying (A). This battery manufacturing method includes preparing electrode sheets each containing the electrode, the scaling frame member, and the separator welded to the sealing frame member, and preparing the spacer, and repeatedly executing a lamination operation to form the electrode stack assembly and the sealing frame. The lamination operation indicates an operation of stacking the spacer on the electrode sheet, heating a peripheral edge of the stacked spacer from the stacking direction so as to weld the peripheral edge to the electrode sheet, and stacking the electrode sheet on the spacer, heating a peripheral edge of the sealing frame member of the stacked electrode sheet from the stacking direction so as to weld the peripheral edge to the spacer.

The manufacturing method of the fifth aspect includes repeatedly executing the lamination operation to form the electrode stack assembly and the sealing frame. The manufacturing method of the fifth aspect is thereby able to manufacture the battery satisfying the (A). The manufacturing method of the fifth aspect is one in which an operation is performed to heat a peripheral edge of the sealing frame member of the stacked electrode sheet from the stacking direction so as to weld the peripheral edge to the electrode sheet, and then furthermore stacking the electrode sheet thereon, heating a peripheral edge of the scaling frame member of the stacked electrode sheet from the stacking direction so as to weld the peripheral edge to the spacer. Welding by performing heating from the stacking direction facilitates control of the length of the welded location. This means that there is no need to design a longer weld length (for example, the length L901 in FIG. 10) in order to secure sealing ability, and the structural efficiency of the battery is raised.

As a result thereof, the manufacturing method of the fifth aspect enables manufacture of the battery having excellent structural efficiency and excellent scaling ability.

<6> A battery manufacturing method of a sixth aspect of the present disclosure is a method of manufacturing the battery of any one of <1>, <2>, or <4> satisfying (B). The battery manufacturing method includes preparing electrode sheets each containing the electrode, the sealing frame member, and the separator welded to the sealing frame member, and repeatedly executing a lamination operation to form the electrode stack assembly and the sealing frame. The lamination operation indicates an operation of stacking one of the electrode sheets on another of the electrode sheets, heating a peripheral edge of the sealing frame member of the stacked electrode sheet from the stacking direction so as to weld the peripheral edge to the other electrode sheet.

Furthermore, the manufacturing method of the sixth aspect includes repeatedly executing the lamination operation to form the electrode stack assembly and the scaling frame. The manufacturing method of the sixth aspect is thereby able to manufacture the battery satisfying the (B). The manufacturing method of the sixth aspect is one in which an operation is performed of heating the peripheral edge of the sealing frame member of the stacked electrode sheet from the stacking direction to weld the peripheral edge to the electrode sheet, and then furthermore stacking the electrode sheet thereon and heating the peripheral edge of the sealing frame member of the stacked electrode sheet from the stacking direction to weld the peripheral edge to the spacer. Performing heating from the stacking direction and welding facilitates control of the length of the welded location. This means that there is no need to design a longer weld length (for example, the length L901 in FIG. 10) in order to secure sealing ability, and the structural efficiency of the battery is raised.

As a result thereof, the manufacturing method of the sixth aspect enables manufacture of the battery having excellent structural efficiency and excellent sealing ability.

One embodiment of the present disclosure provides a battery having excellent structural efficiency. Another embodiment of the present disclosure provides a battery manufacturing method capable of manufacturing a battery having excellent structural efficiency and excellent sealing ability.

### BRIEF DESCRIPTION OF DRAWINGS

Exemplary embodiments of the present disclosure will be described in detail based on the following figures, wherein:

FIG. 1 is an external perspective view of a battery according to a first exemplary embodiment of the present disclosure;

FIG. 2 is a cross-section taken along line II-II of FIG. 1;

FIG. 3 is an enlargement of part of FIG. 2;

FIG. 4 is a cross-section to explain a manufacturing method of a battery according to a first exemplary embodiment of the present disclosure;

FIG. 5 is an external perspective view of a battery according to a second exemplary embodiment of the present disclosure;

FIG. 6 is a cross-section taken along line VI-VI of FIG. 5;

FIG. 7 is an enlargement of part of FIG. 6;

FIG. 8 is a cross-section to explain a manufacturing method of a battery according to a second exemplary embodiment of the present disclosure;

FIG. 9 is a cross-section of a stack assembly that is a precursor of a related battery; and

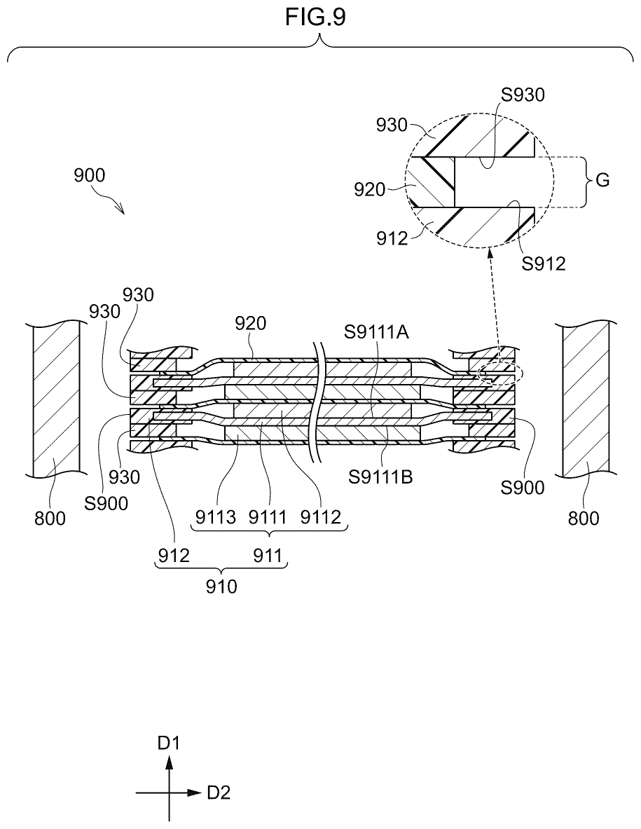

FIG. 10 is a cross-section of a related battery.

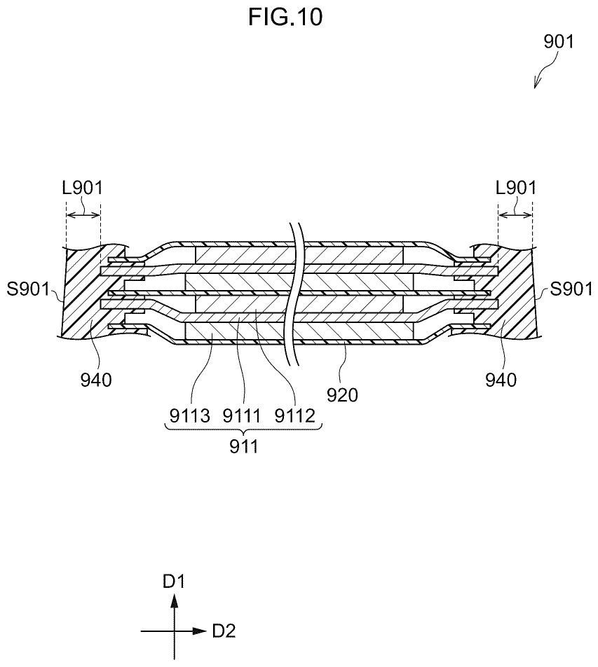

### DETAILED DESCRIPTION

In the present disclosure a numerical range expressed by “from . . . to . . . ” means a range including the respective numerical values before and after “to” as a minimum value and a maximum value of the range. In stepwise numerical ranges referred to in the present disclosure, an upper limit value or a lower limit value of a given numerical range may be replaced by an upper limit value or a lower limit value of another of the stepwise numerical ranges. In the present disclosure, a combination of two or more preferable aspects results in a more preferable aspect. In the present disclosure the term “process” does not merely indicate an independent process, and the term also encompasses cases not clearly distinguishable from another process as long as the intended purpose of the process is achieved.

Explanation follows regarding exemplary embodiments of a battery and a battery manufacturing method of the present disclosure, with reference to the drawings. The same reference numerals will be appended in the drawings to the same or equivalent parts, and duplicate explanation thereof will be omitted.

### (1) First Exemplary Embodiment

### (1. 1) Battery

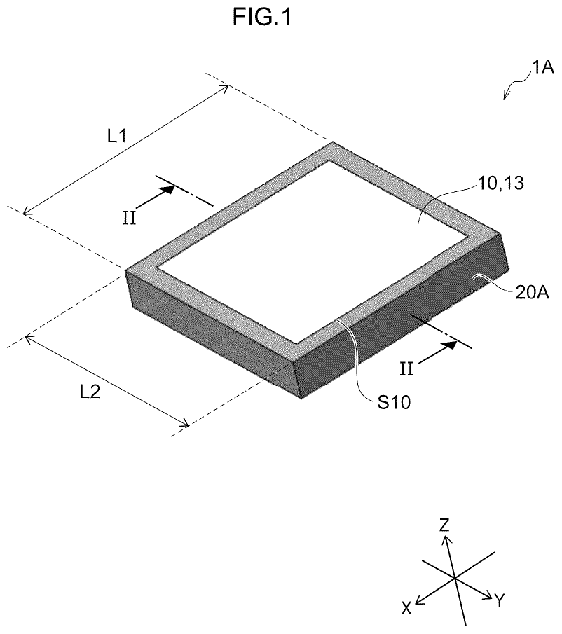

A battery 1A according to a first exemplary embodiment is a cuboidal shaped object, as illustrated in FIG. 1. The battery 1A includes an electrode stack assembly 10, a sealing frame 20A, and a non-aqueous electrolyte (omitted in the drawings). The sealing frame 20A seals side peripheral faces S10 of the electrode stack assembly 10.

In the exemplary embodiment, a long direction of a main face of the battery 1A is defined as being an X axis direction. A short direction of a main face of the battery 1A is defined as being a Y axis direction. A thickness direction of the battery 1A is defined as being a Z axis direction. The X axis, Y axis, and Z axis are orthogonal to each other. The Z axis direction is an example of a stacking direction. The Z axis negative direction and the direction of gravity are parallel. Note that these orientations are not limited to being the orientations when the battery according to the present disclosure is being used.

A length L1 in the X axis direction of the battery 1A (see FIG. 1) and a length L2 in the Y axis direction thereof (see FIG. 1) may each exceed 1 m.

### (1.1.1) Electrode Stack Assembly

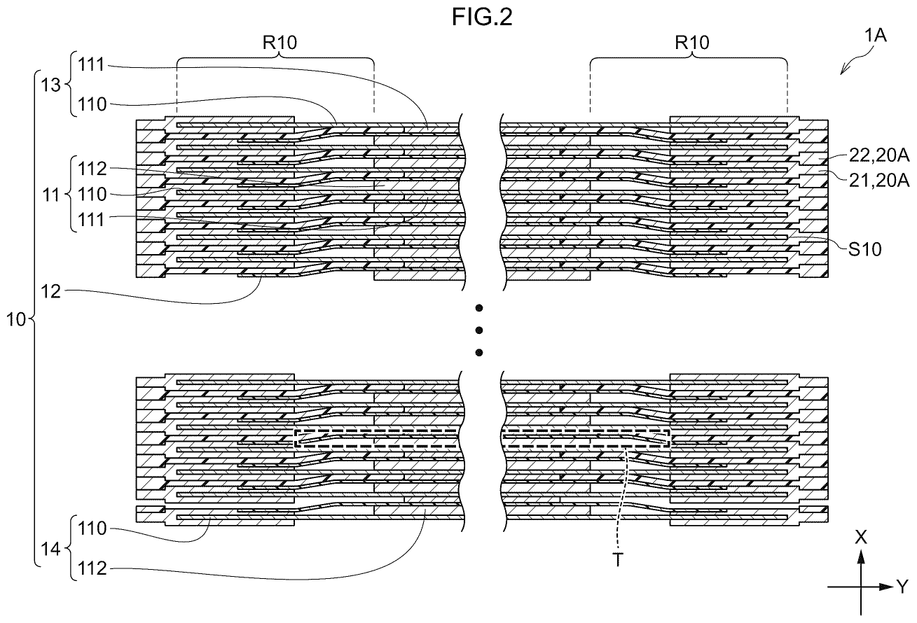

The electrode stack assembly 10 is a cuboidal shaped object. The electrode stack assembly 10 includes plural bipolar electrodes 11 stacked along the Z axis direction, with separators 12 interposed therebetween. More specifically, as illustrated in FIG. 2, the electrode stack assembly 10 includes plural bipolar electrodes 11, plural separators 12, a cathode layer side terminal electrode 13, and an anode layer side terminal electrode 14. The plural bipolar electrodes 11 and the plural separators 12 are stacked alternately along an axial direction. The cathode layer side terminal electrode 13 is stacked against the bipolar electrode 11 positioned furthest in a one stacking direction (on the Z axis direction positive side) from out of the plural bipolar electrodes 11, with one of the separators 12 interposed therebetween. The anode layer side terminal electrode 14 is stacked against the bipolar electrode 11 positioned furthest in the other stacking direction (on the Z axis direction negative side) from out of the plural bipolar electrodes 11, with one of the separators 12 interposed therebetween.

### (1. 1. 1. 1) Bipolar Electrode

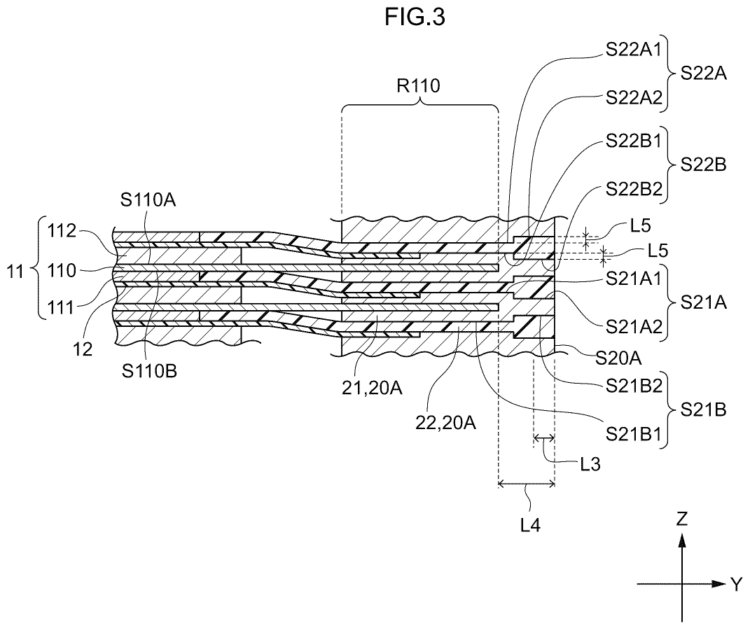

As illustrated in FIG. 3, the bipolar electrodes 11 each include a current collector 110, a cathode layer 111, and an anode layer 112. The cathode layer 111 is formed on a first main face S110A of the current collector 110. The anode layer 112 is formed on a second main face S110B of the current collector 110. The bipolar electrode 11 includes a non-coated portion R10 on both the first main face S110A of the current collector 110 and the second main face S110B of the current collector 110. The non-coated portion R10 is a location formed with neither the cathode layer 111 nor the anode layer 112. The non-coated portion R10 includes a peripheral edge R110 of the current collector 110 (see FIG. 3). A known configuration may be adopted for the bipolar electrode 11. The first main face S110A of the current collector 110 is an example of a one-face of the current collector. The second main face S110B of the current collector 110 is an example of an other-face of the current collector.

The current collector 110 supplies current to the cathode layer 111 and the anode layer 112 when the battery 1A is being charged or discharged. Examples of materials for the current collector 110 include metal foils, conductive resin materials, conductive inorganic materials, and the like. Examples of metal foils include, for example, an aluminum foil, a copper foil, a nickel foil, a titanium foil, a stainless steel foil, and the like. Examples of conductive resin materials include, for example, resins and the like formed from a conductive polymer material, or from a non-conductive polymer material to which a conductive filler has been added as required. A covering layer may be formed on a surface of the current collector 110. Such a covering layer may be formed by a known method (for example, by electroplating, spray coating, or the like). A thickness of the current collector 110 may be from 1 μm to 100 μm.

The cathode layer 111 includes a cathode layer active material capable of storing and releasing a charge carrier (for example, a lithium composite metal oxide including a layered rock salt structure, a metal oxide having a spinel structure, a polyanionic compound, or the like). A thickness (Z axis direction length) of the cathode layer 111 may be from 2 μm to 500 μm.

The anode layer 112 includes an anode layer active material capable of storing and releasing a charge carrier (for example, carbon, a compound capable of forming an alloy with lithium, or the like). Examples of carbon include, for example, natural graphite, synthetic graphite, hard carbon (non graphitizing carbon) or soft carbon (graphitizing carbon). Examples of synthetic graphite include, for example, highly oriented pyrolytic graphite, meso-carbon microbeads, and the like. Examples of elements capable of forming an alloy with lithium include silicon, tin, or the like. A thickness (Z axis direction length) of the anode layer 112 may be formed 2 μm to 500 μm. The thickness of the anode layer 112 may be the same as the thickness of the cathode layer 111, or may be different thereto.

Each of the cathode layer 111 and the anode layer 112 may, as required, further contain a conductivity enhancer to raise electron conductivity, a binder, an electrolyte support salt (lithium salt) to raise ion conductivity, a polymer electrolyte, an additive (for example, trifluoropropylene carbonate, a filler serving as a reinforcement agent, or the like).

Examples of conductivity enhancers include, for example, carbon nanofibers, acetylene black, carbon black, graphite, and the like. Examples of binders include, for example, fluorine containing resins (polyvinylidene fluoride, polytetrafluoroethylene, fluoro rubber, and the like), thermoplastic resins (for example, polypropylene, polyethylene, and the like), imide resins (for example, polyimide, polyamide-imide, and the like), alkoxysilyl group containing resin, acrylic resins (for example, acrylates or methacylates), styrene butadiene rubber (SBR), carboxymethyl cellulose, alginates (for example, sodium alginate or ammonium alginate), crosslinked water soluble cellulose esters, starch-acrylate graft polymers, and the like. Such binding agents may be employed independently or in a combination of plural thereof.

### (1. 1. 1. 2) Separator

The separators 12 serve to maintain spacings between the cathode layers 111 and the anode layers 112, to prevent contact shorting therebetween, and to let a charge carrier such as a lithium ion or the like pass through. A peripheral edge of each of the separators 12 is welded to the sealing frame 20A. The separator 12 is retained by the sealing frame 20A. Examples of the separator 12 include, for example, a multi-porous resin sheet or a non-woven fabric. Examples of materials for the porous resin sheet include, for example, polyolefins (polypropylene, polyethylene, or the like), polyesters, or the like. Examples of materials for the non-woven fabric include, for example, polypropylene, polyethylene terephthalate, or methyl cellulose. A known configuration may be adopted for the separator 12.

### (1. 1. 1. 3) Cathode Layer Side Terminal Electrode

The cathode layer side terminal electrode 13 includes one of the current collectors 110 and one of the cathode layers 111. The cathode layer 111 is formed to the second main face S110B of the current collector 110. A known configuration may be adopted for the cathode layer side terminal electrode 13.

### (1. 1. 1. 4) Anode Layer Side Terminal Electrode

The anode layer side terminal electrode 14 includes one of the current collectors 110 and one of the anode layers 112. The anode layer 112 is formed on the first main face S110A of the current collector 110. A known configuration may be adopted for the anode layer side terminal electrode 14.

### (1. 1. 2) Scaling Frame

The sealing frame 20A forms respective housing portions T between adjacent bipolar electrodes 11 from out of the plural bipolar electrode 11. The cathode layer 111, the anode layer 112, and the separator 12 are housed in the housing portion T in a state containing the non-aqueous electrolyte. The sealing frame 20A prevents external leakage of the non-aqueous electrolyte housed in the housing portion T. The sealing frame 20A is able to prevent penetration of moisture from outside the battery 1A into the housing portion T.

The sealing frame 20A is an angular tube shaped object having a rectangular shaped cross-section. The sealing frame 20A includes plural sealing frame members 21 and plural spacers 22. Each of the plural spacers 22 is disposed between two adjacent sealing frame members 21 from out of the plural sealing frame members 21.

In the first exemplary embodiment, part of each of the interfaces between the plural sealing frame members 21 and the plural spacers 22 is welded. More specifically, in a cross-section sectioned along a direction parallel to the Z axis direction, as illustrated in FIG. 3, a length L3 in a direction orthogonal to the Z axis direction from a side face S20A of the sealing frame 20A at locations where the interface between the spacer 22 and the sealing frame member 21 is welded (hereafter referred to as “weld length L3”) is shorter than a length L4 from the side face S20A of the sealing frame 20A to the current collector 110.

### (1. 1. 2. 1) Sealing Frame Member

The sealing frame members 21 are each an angular tube shaped object having a rectangular shaped cross-section. In the first exemplary embodiment, the sealing frame member 21 is welded to a peripheral edge R110 of the first main face S110A and the second main face S110B of the current collector 110 for each of the plural bipolar electrodes 11.

The sealing frame members 21 each include a flat face location S21A1 and an indented location S21A2 at a first face S21A that contacts the spacer 22 disposed at the Z axis positive direction side thereof. The flat face location S21A1 contacts a flat face location S22B1 of the spacer 22. The indented location S21A2 is depressed from the flat face location S21A1 in the Z axis negative direction.

The sealing frame members 21 each include a flat face location S21B1 and an indented location S21B2 at a second face S21B that contacts the spacer 22 disposed at the Z axis negative direction side thereof. The flat face location S21B1 contacts a flat face location S22A1 of the spacer 22. The indented location S21B2 is depressed from the flat face location S21B1 in the Z axis positive direction.

Examples of materials for the sealing frame members 21 include, for example, polyethylene, polystyrene, an acrylonitrile butadiene styrene copolymer resin (ABS resin), a modified polypropylene, an acrylonitrile styrene resin, or the like.

### (1. 1. 2. 2) Spacer

The spacers 22 are each an angular tube shaped object having a rectangular shaped cross-section.

The spacers 22 each include a flat face location S22A1 and a protruded location S22A2 at a first face S22A that contacts the sealing frame member 21 disposed at the Z axis positive direction side thereof. The protruded location S22A2 projects out from the flat face location S22A1 in the Z axis positive direction.

The spacers 22 each include a flat face location S22B1 and a protruded location S22B2 at a second face S22B that contacts the sealing frame member 21 disposed at the Z axis negative direction side thereof. The protruded location S22B2 projects out from the flat face location S22B1 in the Z axis negative direction.

The protruded location S22A2 of the spacer 22 fits together with the indented location S21B2 of the adjacent sealing frame member 21. The protruded location S22B2 of the spacer 22 fits together with the indented location S21A2 of the adjacent sealing frame member 21.

In the first exemplary embodiment, a height L5 in the Z axis direction of the protruded location S22A2 from the flat face location S22A1 of the spacer 22 is from 0.25 times to 1 times a thickness of the current collector 110 (namely the Z axis direction of the current collector 110). In the first exemplary embodiment, a height L5 in the Z axis direction of the protruded location S22B2 from the flat face location S22B1 of the spacer 22 is from 0.25 times to 1 times the thickness of the current collector 110.

Examples of materials of the spacers 22 include, for example, polyethylene, polystyrene, an acrylonitrile butadiene styrene copolymer resin (ABS resin), a modified polypropylene, an acrylonitrile styrene resin, or the like. The material of the spacers 22 may be the same as the material of the sealing frame members 21, or may be different therefrom.

### (1. 1. 3) Non-Aqueous Electrolyte

The non-aqueous electrolyte is housed in the housing portion T. The non-aqueous electrolyte may contain a non-aqueous solvent, and a lithium salt. Examples of the lithium salt include, for example, LiClO₄, LiAsF₆, LiPF₆, LiBF₄, LiCF₃SO₃, LiN(FSO₂)₂, LiN(CF₃SO₂)₂, and the like. Examples of the non-aqueous solvent include cyclic carbonates, cyclic esters, chain carbonates, chain esters, ethers, and the like. The non-aqueous electrolyte may include an additive (for example lithium bis-(oxalate-) borate or the like) or the like.

### (1. 1. 4) Application

Applications of the battery 1A may, for example, be use as a power source for a four-wheeled electric vehicle, a two-wheeled electric vehicle, a portable machine, a power storage system, or the like. Examples of four-wheeled electric vehicles include battery electric vehicles (BEV), plug-in hybrid electric vehicles (PHEV), and hybrid electric vehicles (HEV). Examples of two-wheeled electric vehicles include electric motorbikes and mopeds, and electric-assist bicycles. Examples of portable machines include, for example, smartphones, tablet computers, notebook computers, electric tools, video cameras, and the like. Examples of power storage systems include domestic power storage systems, industrial power storage systems, energy storage systems (ESS), and the like.

### (1. 2) Manufacturing Method

The battery manufacturing method according to the first exemplary embodiment includes a preparation process, a stacking-welding process, a pressure reduction process, and a liquid injection process. The preparation process, the stacking-welding process, the pressure reduction process, and the liquid injection process are executed in this sequence. The battery 1A is obtained thereby.

### (1. 2. 1) Preparation Process

In the preparation process, plural electrode sheets 31A, plural of the spacers 22, a cathode layer side terminal electrode sheet 32A, and an anode layer side terminal electrode sheet 33A, are each prepared.

The electrode sheets 31A each include the bipolar electrode 11, the sealing frame member 21, and the separator 12. The sealing frame member 21 is welded to the peripheral edge R110 of the first main face S110A and the second main face S110B of the current collector 110 of the bipolar electrode 11. The separator 12 is welded to the sealing frame member 21.

The cathode layer side terminal electrode sheet 32A includes the cathode layer side terminal electrode 13 and the sealing frame member 21. The sealing frame member 21 is welded to the peripheral edge R110 of the current collector 110 of the cathode layer side terminal electrode 13.

The anode layer side terminal electrode sheet 33A includes the anode layer side terminal electrode 14 and the sealing frame member 21. The sealing frame member 21 is welded to the peripheral edge R110 of the current collector 110 of the anode layer side terminal electrode 14.

Any known method may be employed as the respective methods for preparing the electrode sheets 31A, the cathode layer side terminal electrode sheet 32A, the anode layer side terminal electrode sheet 33A, and the spacers 22.

### (1. 2. 2) Stacking-Welding Process

A lamination operation is repeatedly performed in the stacking-welding process to form the electrode stack assembly 10 and the sealing frame 20A. The lamination operation indicates an operation to stack one of the spacers 22 on one of the electrode sheets 31A, to heat a peripheral edge R22 of the spacer 22 from the Z axis direction to weld the peripheral edge R22 to the electrode sheet 31A, to stack the electrode sheet 31A on the spacer 22, to heat a peripheral edge R21 of the sealing frame member 21 of the stacked electrode sheet 31A from the Z axis direction, and to weld the stacked electrode sheet 31A to the spacer 22.

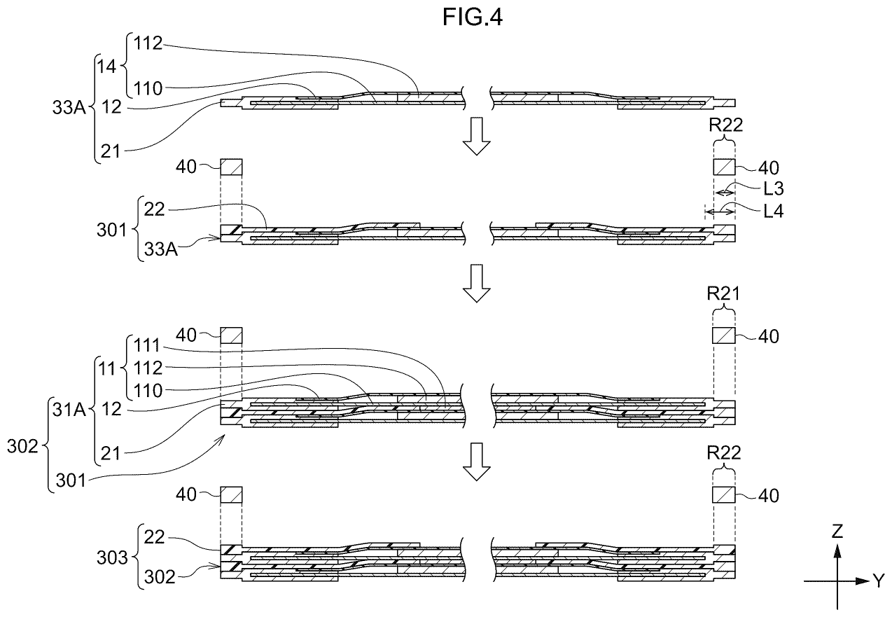

More specifically, as illustrated in FIG. 4, one of the spacers 22 is stacked on the anode layer side terminal electrode sheet 33A. Next, the peripheral edge R22 of the stacked spacer 22 is heated from the Z axis direction with a heating device 40, and welded to the anode layer side terminal electrode sheet 33A. The anode layer side terminal electrode sheet 33A and the spacer 22 are thereby integrated together to obtained a laminated integrated object 301.

Next, one of the electrode sheets 31A is stacked on the spacer 22 of the laminated integrated object 301. Next, the peripheral edge R21 of the sealing frame member 21 of the stacked electrode sheet 31A is heated from the Z axis direction by the heating device 40 and welded to the spacer 22 of the laminated integrated object 301. The laminated integrated object 301 and the electrode sheet 31A are thereby integrated together to obtain a laminated integrated object 302.

Next, one of the spacers 22 is stacked on the electrode sheet 31A of the laminated integrated object 302. Next, the peripheral edge R22 of the stacked spacer 22 is heated from the Z axis direction by the heating device 40 and welded to the electrode sheet 31A of the laminated integrated object 302. The laminated integrated object 302 and the spacer 22 are thereby integrated together to obtain a laminated integrated object 303.

Such a lamination operation is repeatedly performed.

Finally, the cathode layer side terminal electrode sheet 32A is stacked on the spacer 22 of the laminated integrated object resulting from the repeated lamination operation. Next, the peripheral edge R21 of the sealing frame member 21 of the stacked cathode layer side terminal electrode sheet 32A is heated from the Z axis direction by the heating device 40 and welded to the spacer 22 of the laminated integrated object. The laminated integrated object and the cathode layer side terminal electrode sheet 32A are thereby integrated together to form the electrode stack assembly 10 and the sealing frame 20A. In other words a first battery precursor is obtained. The first battery precursor is configured similarly to the battery 1A, except in that there is no non-aqueous electrolyte housed inside the housing portion T.

The heating method of the heating device 40 is not particularly limited and may be any method that enables the sealing frame member 21 and the spacer 22 to be respectively welded, with examples thereof including, for example, laser heating, infrared ray (IR) heating, microwave heating, induction heating, hot-air heating, hot-plate heating, hot-roll heating, or the like. The heating method of the heating device 40 is preferably laser heating from the perspective of controlling the weld length L3 with good precision.

### (1. 2. 3) Pressure Reduction Process

The pressure inside the housing portion T of the first battery precursor is lowered in the pressure reduction process. The air in the housing portion T is thereby externally discharged from the first battery precursor. As a result thereof, injection of the non-aqueous electrolyte into the housing portion T is facilitated. Any known method may be employed as the method to reduce the pressure inside the housing portion T.

### (1. 2. 4) Liquid Injection Process

In the liquid injection process, the non-aqueous electrolyte is injected into the housing portion T of the first battery precursor. The battery 1A is obtained thereby. Any known method may be employed as the method for injecting the non-aqueous electrolyte.

### (1. 3) Operation and Advantageous Effects

As described with reference to FIG. 1 to FIG. 4, the battery 1A includes the electrode stack assembly 10, the sealing frame 20A, and the non-aqueous electrolyte. The bipolar electrode 11 includes the current collector 110, the cathode layer 111, and the anode layer 112. The sealing frame 20A includes the sealing frame members 21 and the spacers 22. The spacers 22 each include the flat face location S22A1 and the protruded location S22A2 on the first face S22A. The spacers 22 also each include the flat face location S22B1 and the protruded location S22B2 on the second face S22B. The sealing frame members 21 each include the flat face location S21A1 and the indented location S21A2 on the first face S21A. The sealing frame members 21 also each include the flat face location S21B1 and the indented location S21B2 on the second face S21B. The protruded location S22A2 fits together with the indented location S21B2. The protruded location S22B2 fits together with the indented location S21A2.

This accordingly means that a void is not readily formed at the interfaces between the spacers 22 and the sealing frame members 21. The shape of the sealing frame member 21 is accordingly not liable to deform when welding the sealing frame member 21. The side face S20A of the battery 1A configured by the sealing frame 20A is accordingly a perpendicular face. As a result thereof the battery 1A has excellent structural efficiency.

As described with reference to FIG. 1 to FIG. 4, in a cross-section of the battery 1A sectioned along a direction parallel to the Z axis direction, the weld length L3 (see FIG. 3) is shorter than the length LA (see FIG. 3) in a direction orthogonal to the Z axis direction.

This means that localized stress caused by change in volume is less liable to be imparted to the sealing frame 20A than cases in which the entire area of the interfaces between the sealing frame members 21 and the spacers 22 is welded. As a result thereof, cracks are not liable to develop in the sealing frame 20A even when cooling-heating cycle tests are executed on the battery 1A. Namely, the battery 1A has excellent scaling ability.

As described with reference to FIG. 1 to FIG. 4, the height L5 (see FIG. 3) is from 0.25 times to 1 times the thickness of the current collector 110.

This means that the quality of contact between the spacer 22 and the sealing frame member 21 is superior to configurations in which the height L5 is outside of the range of 0.25 times to 1 times the thickness of the current collector 110.

As described with reference to FIG. 1 to FIG. 4, the battery manufacturing method of the first exemplary embodiment is a method to manufacture the battery 1A. The manufacturing method includes the preparation process and the stacking-welding process. The lamination operation indicates an operation in which the spacer 22 is stacked on one of the electrode sheets 31A, the peripheral edge R21 of the stacked spacer 22 is heated from the Z axis direction and welded to the electrode sheet 31A, one of the electrode sheets 31A is stacked on the spacer 22, and the peripheral edge R21 of the sealing frame member 21 of the stacked electrode sheet 31A is heated from the Z axis direction and welded to the spacer 22.

The manufacturing method of the first exemplary embodiment enables manufacture of the battery 1A having excellent structural efficiency. Furthermore, in the manufacturing method of the first exemplary embodiment, control of the weld length L3 is facilitated by welding being performed by heating from the stacking direction (Z axis direction). This means that there is no need to design a longer weld length L3 in order to secure sealing ability, and the structural efficiency of the battery 1A is raised.

As a result thereof the manufacturing method of the first exemplary embodiment enables manufacture of the battery 1A having excellent structural efficiency and excellent sealing ability.

### (2) Second Exemplary Embodiment

### (2.1) Battery

A battery 1B according to the second exemplary embodiment of the present disclosure is configured mainly similarly to the battery 1A of the first exemplary embodiment, except in that spacers are not provided.

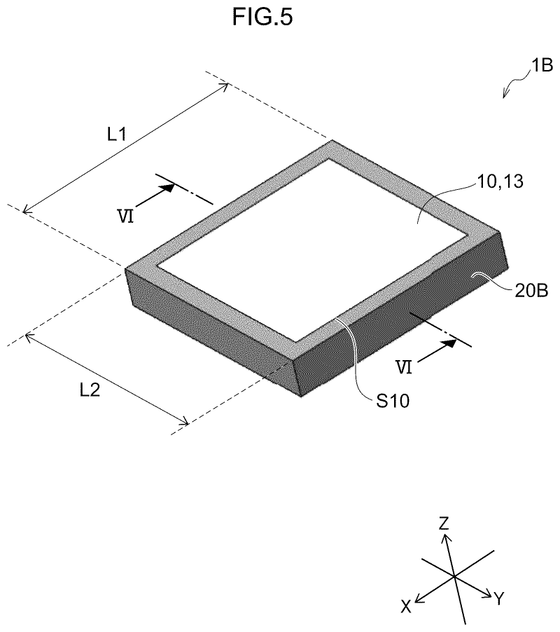

The battery 1B is, as illustrated in FIG. 5, provided with an electrode stack assembly 10, a sealing frame 20B, and a non-aqueous electrolyte (omitted in the drawings). The sealing frame 20B seals side peripheral faces S10 of the electrode stack assembly 10.

### (2. 1. 1) Sealing Frame

The sealing frame 20B is configured mainly similarly to the sealing frame 20A, except in that spacers are not provided.

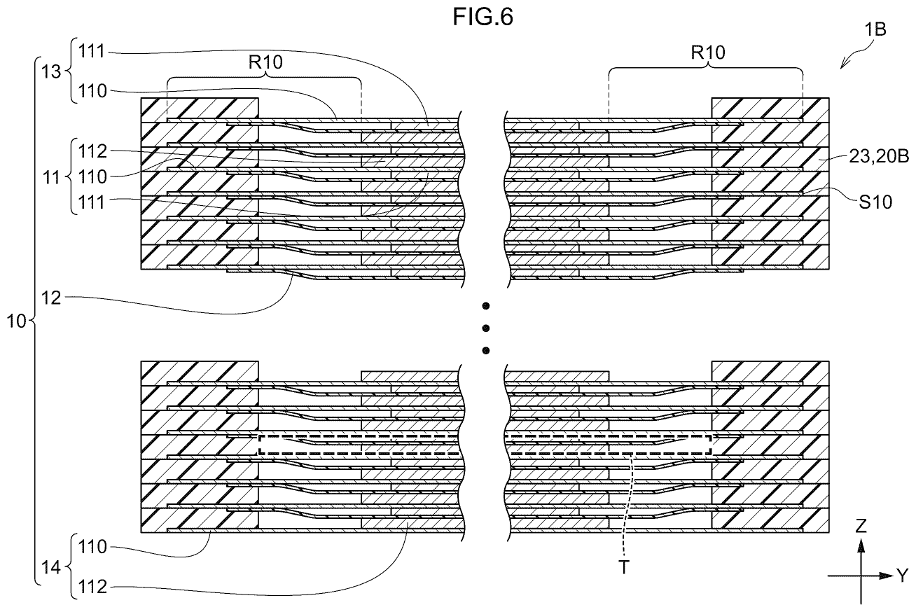

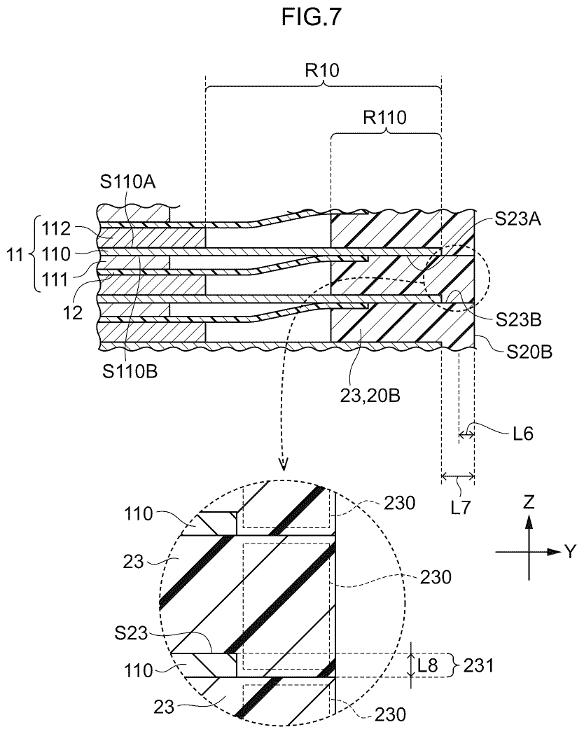

The sealing frame 20B includes plural sealing frame members 23, as illustrated in FIG. 6. As illustrated in FIG. 7, the sealing frame members 23 are each welded to part of a non-coated portion R10 of a first main face S110A of the current collector 110 (namely, to a peripheral edge R110). The sealing frame members 23 each include an extension portion 230. The extension portion 230 extends from the current collector 110 in a plane direction of the current collector 110 orthogonal to the Z axis direction (stacking direction). The extension portions 230 are each directly connected to the adjacent sealing frame members 23. Namely, a spacer is not interposed between respective adjacent sealing frame members 23.

In the second exemplary embodiment, part of each of the interfaces between adjacent sealing frame members 23 is welded. More specifically, in a cross-section sectioned along a direction parallel to the Z axis direction, as illustrated in FIG. 7, a length L6 in a direction orthogonal to the Z axis direction of locations where the interface between the adjacent sealing frame members 23 is welded from a side face S20B of the scaling frame 20B (hereafter referred to as “weld length L6”), is shorter than a length L7 from the side face S20B of the sealing frame 20B to the current collector 110.

The sealing frame members 23 are each an angular tube shaped object having a rectangular shaped cross-section. In the second exemplary embodiment, the sealing frame members 23 are each welded to a peripheral edge R110 of the first main face S110A of the current collector 110 of the plural respective bipolar electrodes 11.

A face S23A that contacts the sealing frame member 23 disposed on the Z axis positive direction side of the sealing frame member 23 is a flat face. A face S23B that contacts the sealing frame member 23 disposed on the Z axis negative direction side of the sealing frame member 23 is also a flat face. The sealing frame member 23 are each welded at least at part of the non-coated portion of at least one out of the one-face or the other-face of the current collector, and the sealing frame members 23 each include the extension portion that extends from the current collector in the plane direction of the current collector, with the extension portions directly contacting the adjacent sealing frame members.

In the second exemplary embodiment, the extension portion 230 of the sealing frame member includes a projection portion 231 that projects out from a welding face S23 welded to the current collector 110. A thickness L8 (see FIG. 7) in the Z axis direction (stacking direction) from the welding face S23 is from 1 times to 2 times the thickness of the current collector 110 (Z axis direction length of the current collector 110).

Examples of materials for the sealing frame members 23 include, for example, poly polyethylene, polystyrene, an acrylonitrile butadiene styrene copolymer resin (ABS resin), a modified polypropylene, an acrylonitrile styrene resin, or the like.

### (2. 1. 2) Applications

Examples of applications of the battery 1B are similar to those of the examples for applications of the battery 1A.

### (2. 2) Manufacturing Method

The manufacturing method of a battery according to the second exemplary embodiment includes a preparation process, a stacking-welding process, a pressure reduction process, and a liquid injection process. The preparation process, the stacking-welding process, the pressure reduction process, and the liquid injection process are executed in this sequence. The battery 1B is obtained thereby.

### (2. 2. 1) Preparation Process

The preparation process includes preparation of plural electrode sheets 31B, plural spacers 22, a cathode layer side terminal electrode sheet 32B, and an anode layer side terminal electrode sheet 33B.

The electrode sheets 31B each include a bipolar electrode 11, a sealing frame member 23, and a separator 12. The sealing frame member 23 is welded to the peripheral edge R110 of the first main face S110A of the current collector 110 of the bipolar electrode 11. The separator 12 is welded to the sealing frame member 23.

The cathode layer side terminal electrode sheet 32B includes the cathode layer side terminal electrode 13 and the sealing frame member 23. The sealing frame member 23 is welded to the peripheral edge R110 of the current collector 110 of the cathode layer side terminal electrode 13.

The anode layer side terminal electrode sheet 33B includes the anode layer side terminal electrode 14 and the sealing frame member 23. The sealing frame member 23 is welded to the peripheral edge R110 of the current collector 110 of the anode layer side terminal electrode 14.

Any known method may be employed for the respective preparation method of the electrode sheets 31B, the cathode layer side terminal electrode sheet 32B, and the anode layer side terminal electrode sheet 33B.

### (2. 2. 2) Stacking-Welding Process

A lamination operation is repeatedly executed in the stacking-welding process to form the electrode stack assembly 10 and the sealing frame 20B. The lamination operation indicates an operation in which the electrode sheet 31B is stacked on one of the electrode sheets 31B, and a peripheral edge R23 of the sealing frame member 23 of the stacked electrode sheet 31B is heated from the Z axis direction and welded to the electrode sheet 31B.

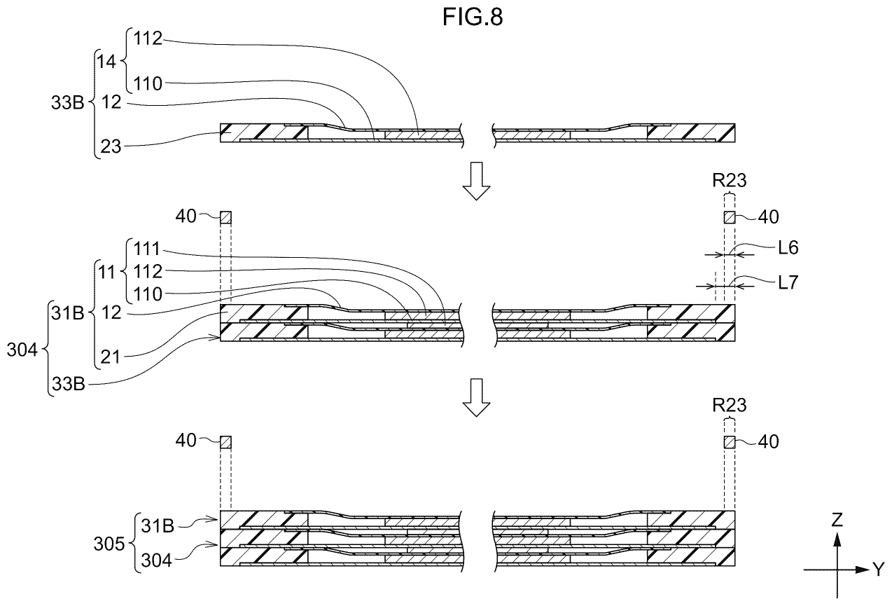

More specifically, as illustrated in FIG. 8, one of the electrode sheets 31B is stacked on the anode layer side terminal electrode sheet 33B. Next, the peripheral edge R23 of the sealing frame member 23 of the stacked electrode sheet 31B is heated from the Z axis direction by the heating device 40 and welded to the anode layer side terminal electrode sheet 33B. The anode layer side terminal electrode sheet 33B and the electrode sheet 31B are thereby integrated together to obtain a laminated integrated object 304.

Next, one of the electrode sheets 31B is stacked on the electrode sheet 31B of the laminated integrated object 304. Next, the peripheral edge R23 of the sealing frame member 23 of the stacked electrode sheet 31B is heated from the Z axis direction by the heating device 40 and welded to the sealing frame member 23 of the laminated integrated object 304. The laminated integrated object 304 and the electrode sheet 31B are thereby integrated together to obtain a laminated integrated object 305.

Such a lamination operation is performed repeatedly.

Finally, the cathode layer side terminal electrode sheet 32B is stacked on the electrode sheet 31B of the laminated integrated object resulting from the repeated lamination operation. Next, the peripheral edge R23 of the sealing frame member 23 of the stacked cathode layer side terminal electrode sheet 32B is heated from the Z axis direction by the heating device 40 and welded to the scaling frame member 23 of the laminated integrated object. The laminated integrated object and the cathode layer side terminal electrode sheet 32B are thereby integrated together, and the electrode stack assembly 10 and the scaling frame 20B are formed. In other words, a second battery precursor is obtained. The second battery precursor is configured similarly to the battery 1B except in that there is no non-aqueous electrolyte housed inside the housing portion T.

Similar examples may be given for the heating method of the heating device 40 to the heating method of the heating device 40 of the first exemplary embodiment. The heating method of the heating device 40 is preferably laser heating from the perspective of controlling the weld length L6 with good precision.

### (2. 2. 3) Pressure Reduction Process

The pressure inside the housing portion T of the second battery precursor is lowered in the pressure reduction process. The air in the housing portion T is thereby discharged to outside the second battery precursor. As a result thereof, injection of the non-aqueous electrolyte into the housing portion T is facilitated. Any known method may be employed as the method to reduce the pressure inside the housing portion T.

### (2. 2. 4) Liquid Injection Process

In the liquid injection process the non-aqueous electrolyte is injected into the housing portion T of the second battery precursor. The battery 1B is obtained thereby. Any known method may be employed as the method for injecting the non-aqueous electrolyte.

### (2. 3) Operation and Advantageous Effects

As described with reference to FIG. 5 to FIG. 8, the battery 1B includes the electrode stack assembly 10, the sealing frame 20B, and the non-aqueous electrolyte. The bipolar electrode 11 includes the current collector 110, the cathode layer 111, and the anode layer 112. The scaling frame 20B includes the sealing frame member 23. The sealing frame member 23 includes the extension portion 230. The extension portion 230 is directly connected to the adjacent sealing frame member 23.

A void is accordingly not liable to be formed at the interface between two adjacent sealing frame members 23 from out of the sealing frame members 23. The shape of the sealing frame member 23 is accordingly not liable to deform when welding the sealing frame member 23. The side face of the battery 1B configured by the sealing frame 20B is accordingly a perpendicular face. As a result thereof the battery 1B has excellent structural efficiency.

As described with reference to FIG. 5 to FIG. 8, in a cross-section sectioned along a direction parallel to the Z axis direction, the weld length L6 (see FIG. 7) in a direction orthogonal to the Z axis direction is shorter than the length L7 (see FIG. 7) from the side face S20B of the sealing frame 20B to the current collector 110.

Localized stress caused by change in volume is less liable to be imparted to the sealing frame 20B than cases in which the entire area of the interface between the two adjacent sealing frame members 23 from out of the sealing frame members 23 is welded. As a result thereof, cracks are not liable to develop in the sealing frame 20B even when cooling-heating cycle tests are executed on the battery 1B. Namely, the battery 1B has excellent scaling ability.

As described with reference to FIG. 5 to FIG. 8, the thickness L8 (see FIG. 7) in the Z axis direction from the welding face S23 of the projection portion 231 is from 1 time to 2 times the thickness of the current collector 110.

This means that in the battery 1B the quality of contact between the two adjacent sealing frame members 23 is superior to configurations in which the thickness L8 is outside of the range of 1 time to 2 times the thickness of the current collector 110.

As described with reference to FIG. 5 to FIG. 8, the battery manufacturing method of the second exemplary embodiment is a method for manufacturing the battery 1B. This manufacturing method includes the preparation process, and the stacking-welding process. The lamination operation indicates an operation in which one of the electrode sheets 31B is stacked on another of the electrode sheets 31B, and a peripheral edge R23 of the sealing frame member 23 of the stacked electrode sheet 31B is heated from the Z axis direction and welded to the other electrode sheet 31B.

The manufacturing method of the second exemplary embodiment is accordingly able to manufacture the battery 1B having excellent structural efficiency. Furthermore, in the manufacturing method of the second exemplary embodiment, control of the weld length L6 is facilitated by welding being performed by heating from the stacking direction (Z axis direction). This means that there is no need to design a longer weld length L6 in order to secure sealing ability, and the structural efficiency of the battery 1B is raised.

As a result, the manufacturing method of the second exemplary embodiment is able to manufacture the battery 1B having excellent structural efficiency and excellent sealing ability.

### (3) Modified Examples

In the first exemplary embodiment, the weld length L3 (see FIG. 3) is shorter than the length L4 (see FIG. 3), however the present disclosure is not limited thereto. In the present disclosure, the weld length L3 may be the same as the length LA, and may be longer than the length L4.

In the first exemplary embodiment, the height L5 (see FIG. 3) is from 0.25 times to 1 time the thickness of the current collector 110, however the present disclosure is not limited thereto. In the present disclosure, the height L5 may fall outside the range of from 0.25 times to 1 time the thickness of the current collector 110.

In the second exemplary embodiment, the weld length L6 (see FIG. 7) is shorter than the length L7 (see FIG. 7), however the present disclosure is not limited thereto. In the present disclosure, the weld length L6 may be the same as the length L7, and may be longer than the length L7.

In the second exemplary embodiment, the Y axis direction thickness L8 (see FIG. 7) of the sealing frame member 23 is from 1 time to two times the thickness of the current collector 110, however the present disclosure is not limited thereto. In the present disclosure, the L8 may fall outside the range of from 1 time to 2 times the thickness of the current collector 110.

In the first exemplary embodiment and the second exemplary embodiment, the electrode stack assembly 10 includes the plural bipolar electrodes 11, however the present disclosure is not limited thereto. In the present disclosure, the electrode stack assembly 10 may include a monopolar electrode instead of the plural bipolar electrodes 11. A monopolar electrode includes a cathode and an anode, as illustrated in FIG. 3. The cathode includes a current collector 110, and a cathode layer 111 formed to both a first main face S110A and a second main face S110B of the current collector 110. The anode includes the current collector 110, and the anode layer 112 formed to both the first main face S110A and the second main face S110B of the current collector 110.

### EXPLANATION OF THE REFERENCE NUMERALS

1A: battery, 1B: battery, 10: electrode stack assembly, 11: bipolar electrode, 12: separator, 13: cathode layer side terminal electrode, 14: anode layer side terminal electrode, 20A: sealing frame, 20B: sealing frame, 21: sealing frame member, 22: spacer, 23: sealing frame member, 31A: electrode sheet, 31B: electrode sheet, 32A: cathode layer side terminal electrode sheet, 32B: cathode layer side terminal electrode sheet, 33A: anode layer side terminal electrode sheet, 33B: anode layer side terminal electrode sheet, 40: heating device, 110: current collector, 111: cathode layer, 112: anode layer, 301: laminated integrated object, 302: laminated integrated object, 303: laminated integrated object, 304: laminated integrated object, 305: laminated integrated object, R21: peripheral edge, R22: peripheral edge, R23: peripheral edge, R110: peripheral edge, S21A1: flat face location, S21A2: indented location, S21B1: flat face location, S21B2 indented location, S22A1: flat face location, S22A2: protruded location, S22B1: flat face location, S22B2: protruded location

What is claimed is:

1. A battery comprising:
an electrode stack assembly containing a plurality of electrodes stacked in a stacking direction with a separator interposed therebetween;
a sealing frame that seals a side peripheral face of the electrode stack assembly and that forms a housing portion between adjacent electrodes from out of the plurality of electrodes; and
a non-aqueous electrolyte that is housed in the housing portion, wherein:
the electrode includes a current collector and at least one out of a cathode layer or an anode layer;
the electrode includes a non-coated portion where neither the cathode layer nor the anode layer are formed on a one-face and an other-face of the current collector;
the sealing frame includes a sealing frame member welded to at least part of the non-coated portion of at least one out of the one-face or the other-face of the current collector for each of the plurality of electrodes; and
the battery satisfies following (A) or (B):
(A)
the sealing frame further includes a spacer arranged between two adjacent sealing frame members from out of the plurality of sealing frame members,
at a portion of the spacer contacting the two adjacent sealing frame members the spacer includes a first flat face location and a protruded location that projects out in the stacking direction from the first flat face location, and
at a portion of the sealing frame member contacting the two adjacent spacers, the sealing frame member includes a second flat face location contacting the first flat face location, and an indented location depressed in the stacking direction from the second flat face location, and
the protruded location fits together with the indented location; or
(B)
the sealing frame members are each welded to at least part of the non-coated portion of one out of the one-face or the other-face of the current collector,
the sealing frame member includes an extension portion that extends from the current collector in a plane direction of the current collector orthogonal to the stacking direction, and
the extension portion directly contacts an adjacent sealing frame member.

2. The battery of claim 1, wherein:
in cases in which (A) is satisfied, in a cross-section sectioned along the stacking direction, a length in a direction orthogonal to the stacking direction of a welded location of an interface between the spacer and the sealing frame member from a side face of the sealing frame is shorter than a length from the sealing frame side face to the current collector; and
in cases in which (B) is satisfied, in a cross-section sectioned along the stacking direction, a length in a direction orthogonal to the stacking direction of a welded location of an interface between the adjacent sealing frame members from a side face of the sealing frame is shorter than from a length from the sealing frame side face to the current collector.

3. The battery of claim 1, wherein:
the (A) is satisfied; and
a height in the stacking direction of the protruded location from the first flat face location of the spacer is from 0.25 times to 1 time a thickness of the current collector.

4. The battery of claim 2, wherein:
the (A) is satisfied; and
a height in the stacking direction of the protruded location from the first flat face location of the spacer is from 0.25 times to 1 time a thickness of the current collector.

5. The battery of claim 1, wherein:
the (B) is satisfied;
the sealing frame member includes a projection portion on the extension portion that projects out from a welded surface welded to the current collector; and
a thickness in the stacking direction of the projection portion from the welded surface is from 1 time to 2 times a thickness of the current collector.

6. The battery of claim 2, wherein:
the (B) is satisfied;
the sealing frame member includes a projection portion on the extension portion that projects out from a welded surface welded to the current collector; and
a thickness in the stacking direction of the projection portion from the welded surface is from 1 time to 2 times a thickness of the current collector.

7. A battery manufacturing method that is a method of manufacturing the battery of claim 1 satisfying (A), wherein the battery manufacturing method comprises:
preparing electrode sheets each containing the electrode, the sealing frame member, and the separator welded to the sealing frame member, and preparing the spacer; and
repeatedly executing a lamination operation to form the electrode stack assembly and the sealing frame, wherein
the lamination operation indicates an operation of
stacking the spacer on the electrode sheet, heating a peripheral edge of the stacked spacer from the stacking direction so as to weld the peripheral edge to the electrode sheet, and
stacking the electrode sheet on the spacer, heating a peripheral edge of the sealing frame member of the stacked electrode sheet from the stacking direction so as to weld the peripheral edge to the spacer.

8. A battery manufacturing method that is a method of manufacturing the battery of claim 1 satisfying (B), wherein the battery manufacturing method comprises:
preparing electrode sheets each containing the electrode, the sealing frame member, and the separator welded to the sealing frame member; and
repeatedly executing a lamination operation to form the electrode stack assembly and the sealing frame, wherein
the lamination operation indicates an operation of stacking one of the electrode sheets on another of the electrode sheets, heating a peripheral edge of the sealing frame member of the stacked electrode sheet from the stacking direction so as to weld the peripheral edge to the other electrode sheet.
